(19) United States
(12) Patent Application Publication
(10) Pub. No.: US 2013/0262237 A1
(43) Pub. Date: Oct. 3, 2013

(54) METHOD OF MARKETING BASED UPON A SAVINGS GOAL

(71) Applicant: Jon M. Gaskell, II, West Des Moines, IA (US)

(72) Inventor: Jon M. Gaskell, II, West Des Moines, IA (US)

(73) Assignee: SmartyPig, L.L.C. d.b.a. Social Money, West Des Moines, IA (US)

(21) Appl. No.: 13/437,528

(22) Filed: Apr. 2, 2012

(51) Int. Cl. G06Q 30/02

(52) U.S. Cl. 705/14.66

(57) ABSTRACT

A method of marketing related to a saving goal that includes a goal saver program having a management console. The management console permits a financial institution to configure a saving goal account, generate reports related to the savings goal accounts, and send targeted messages through a customer engagement engine based upon selected criteria related to the savings goal information and selected distribution channels.

### BACKGROUND OF THE INVENTION

This invention is directed toward a method of marketing based upon a savings goal and more specifically to a method of utilizing savings goal information to market products and services related to a savings goal.

As the Internet and social networking have become more prevalent, entities such as financial institutions are challenged to maintain and develop personal relationships with customers. While various savings programs are known in the art, utilizing information related to the savings program to build a more effective relationship is difficult as often the information is not available, or is stored in such a manner that the information is difficult to sort in order to provide meaningful information to build a better relationship. Even if assembled, there exists no relatively simple and efficient method to utilize the information in a manner that benefits both the consumer and the financial institution. Accordingly, there exists a need in the art for a method or system that addresses these deficiencies.

Therefore, an objective of the present invention is to provide a method to market selected products to customers based upon their savings goals.

A further objective of this invention is to provide a method where information related to a savings goal is managed and used to build a personal relationship with a consumer.

A still further objective of the present invention is to provide a method of marketing based upon a savings goal where marketing messages are created related to savings goal criteria.

These and other objective will be apparent to one skilled in the art based upon the following written description, drawings and claims.

### BRIEF SUMMARY OF THE INVENTION

The method of marketing based upon a savings goal includes a savings goal program having a management console. The management console permits the configuration of goal savings accounts based upon desired procedures, rules, and regulations. Once configured, through the management console, information is sorted to generate reports based on selected criteria to assist in making plans and decisions for building and maintaining a good relationship with consumers.

The management console has a customer engagement engine that permits targeted messaging to be sent to consumers based on criteria related to the consumer's savings goal and selected distribution channels. The goal saver program enables a financial institution to gather deposits and cross-sell a variety of products based upon the information related to the goal saver accounts.

### BRIEF DESCRIPTION OF THE DRAWINGS

FIG. 1 is a schematic diagram of an environment for a method of marketing based upon a savings goal;

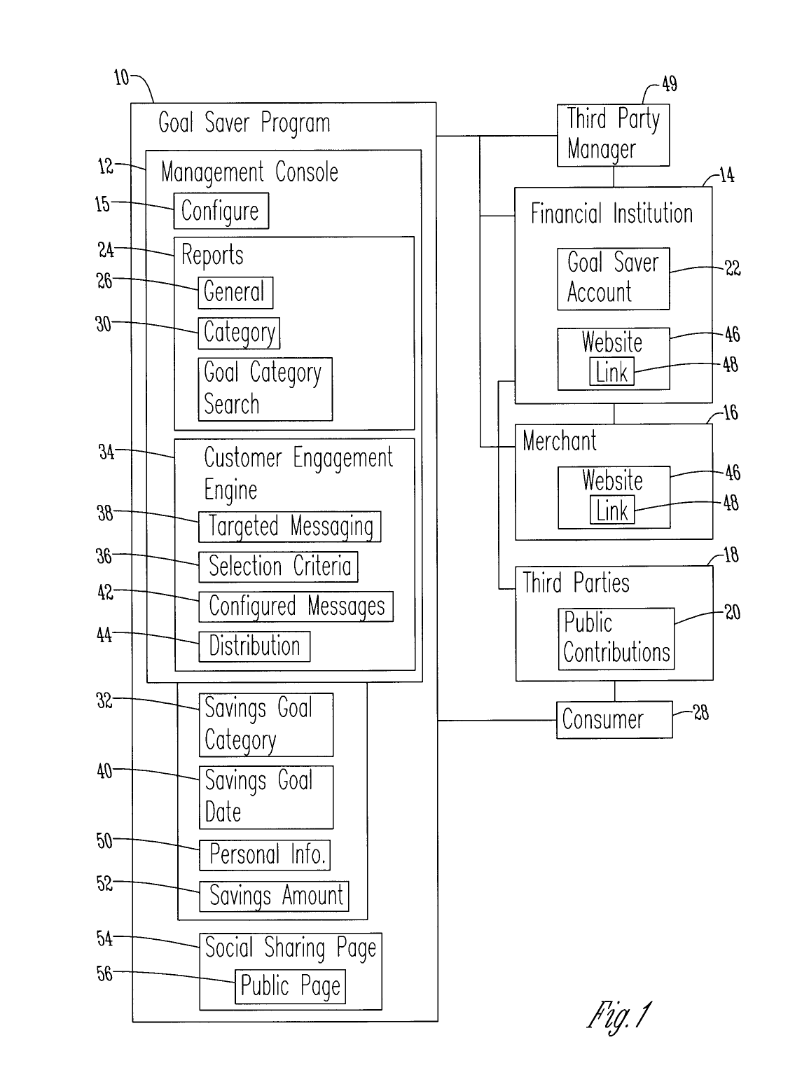

FIG. 2 is a flow diagram of a method of marketing based upon a savings goal; and

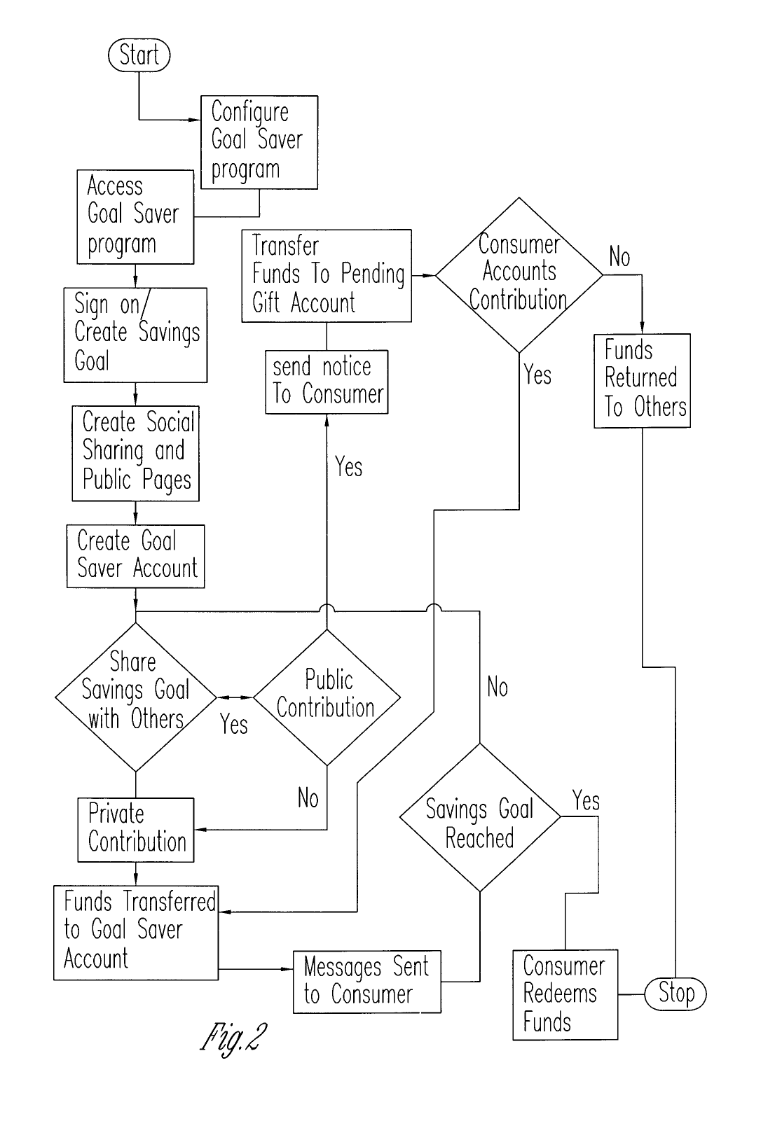

FIG. 3 is a flow diagram of a method for marketing based upon a savings goal.

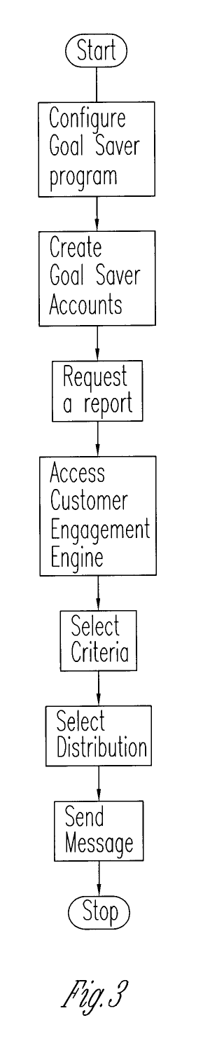

### DETAILED DESCRIPTION OF THE PREFERRED EMBODIMENTS

A method of marketing a product related to a savings goal includes a goal saver program 10 having a management console 12. The management console 12 preferably is a web-based application for use by a financial institution 14 and/or merchant 16 to manage and capitalize upon the goal saver program 10.

Through an electronic network, the management console 12 is accessed, preferably by the financial institution 14, to configure 15 the goal saver program 10 by establishing rules and procedures for various aspects of the program 10 such as, by way of example only, creating social network options and settings; establishing procedures where third parties 18 make public contributions 20 to a goal saver account 22; and outlining parameters so that the program 10 is in compliance with legal and business rules.

The management console 12 is also accessed to generate and provide reports and data 24 to, preferably, the financial institution 14. As an example, upon request, the management console 12 generates general reports 26 which provide statistics on the number of active goal saver accounts 22 per consumer 28, statistics on the destination of funds once a goal is reached (i.e., IRA, merchant, etc.); statistics on the source of the incoming funds (i.e., private or public); and a breakdown of active consumers 28 by geographic area.

The management console 12 also generates category reports 30 that provide data, for example, on the number of active accounts 22, the percent of all active accounts 22 in a category, the average amount saved to date, and the average goal amount based upon a selected savings goal category 32. Also a goal category search report is provided based upon the selected search term related to the savings goal category 32, the amount saved, the goal amount, and/or the percent saved to goal rather than the savings goal category 32. This information is used to develop products and services and/or marketing strategies to consumers 28.

The management console 12 also permits the marketing of products and services to consumers 28 through an electronic network by accessing a customer engagement engine 34. Based upon selected criteria 36, the customer engagement engine 34 groups or bundles goal saver accounts 22 for targeted messaging 38. Preferably, the selection criteria 36 is a savings goal category 32 and/or a desired savings goal date 40 (i.e., deadline for reaching savings goal).

Based on the selected criteria 36, the customer engagement engine provides suggested configured messages 42 for different types of distribution 44. The types of distribution include, but are not limited to, e-mail blasts, advertising, alerts, blog content, social networks, and contests. For example, if the selection criteria 36 is for a savings goal date 40 that coincides with black Friday, the customer engagement engine 34 provides configured messages 42 related to black Friday. For the distribution type 44 social network, configured messages 42 that may be edited are provided for use as a Facebook status update, a Twitter status update, and a Google+ status update. The targeted messages 38 are used to promote a specific product, service, or event preferably related to the savings goal category 32.

In operation, once configured through the management console 12, a consumer 28 creates a savings goal account 22 by accessing a website 46 provided by the financial institution 14 or merchant 16. Preferably, the website 46 has a link 48 that transfers the consumer 28 via the electronic network to the goal saver program 10 maintained by a third party manager 49.

The consumer 28 creates a goal savings account 22 by inputting personal information 50, selecting a goal category 32, determining a desired saving amount 52, and determining a savings goal date 40. Preferably, by creating a savings goal account 22, the consumer 28 is provided with a social sharing page 54 where the consumer 28 shares information about the savings goal account with third parties, either privately or publicly through a public page 56.

At any time, reports are generated based upon selected criteria to provide information and data on the savings goal accounts 22 to assist in developing products and marketing plans based upon savings goal data. To send a targeted message 38, a configured message 42 is obtained by selecting criteria 36 from the customer engagement engine. Once approved, the targeted messages 38 are sent to consumers 28 through selected distribution 44 where consumers 28 may share the messages 38 with family and friend or other third parties.

Accordingly, a method of marketing products related to a savings goal has been disclosed that, at the very least, meets all the stated objectives.

What is claimed is:

1. A method of marketing, comprising the steps of:
configuring a goal saver program that allows a plurality of consumers to establish savings goals by accessing the goal saver program through a website via an electronic network;
selecting criteria related to the savings goals on a customer engagement engine wherein the goal saver program provides a configured message related to the selected criteria; and
selecting at least one distribution source wherein the configured message is transmitted to the consumers based on the selected criteria via the electronic network.

2. The method of claim 1 further comprising the step of creating a social sharing page associated with the savings goals that allows the consumers to share the savings goals and messages with others via a social electronic network.

3. The method of claim 2 wherein the social sharing page has a public page that can be viewed by others via the social electronic network.

4. The method of claim 1 wherein the selection criteria includes at least one of a savings goal category and a savings goal date.

5. The method of claim 1 wherein the configured message is edited prior to being transmitted.

6. The method of claim 1 wherein the distribution source includes an e-mail blast, selected advertising, alerts, blog content, social networks, and contests.

7. The method of claim 1 wherein the goal saver program allows public contributions from others.

8. The method of claim 1 further comprising the step of generating reports based upon selected criteria related to the savings goal account.
